(19) United States
(12) Patent Application Publication
(10) Pub. No.: US 2012/0031522 A1
(43) Pub. Date: Feb. 9, 2012

(54) Motorcycle Fork Oil Changer and Method

(76) Inventor: Charles Mantooth, New Market, TN (US)

(21) Appl. No.: 12/852,566

(22) Filed: Aug. 9, 2010

(51) Int. Cl. F16N 31/00

(52) U.S. Cl. 141/1; 141/98

(57) ABSTRACT

A motorcycle fork oil changer and associated method for changing fork oil in a motorcycle fork of the type defining a drain hole allowing access to an interior of the motorcycle fork is disclosed. The motorcycle fork oil changer includes a nozzle defining a through opening and having a gasket configured to surround the drain hole to establish an at least liquid tight seal between the drain hole and the through opening. A valve is provided in at least liquid tight fluid communication with the through opening. The valve is at least openable and closable to regulate fluid flow through the through opening. The valve is capable of being placed in at least liquid tight fluid communication with a fluid reservoir to regulate movement of fluid between the fluid reservoir and the motorcycle fork interior through the drain hole.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to motorcycle maintenance. More particularly, this invention pertains to an apparatus useful in removing and replacing motorcycle fork oil in a motorcycle fork tube.

2. Description of the Related Art

In several designs of modern-day motorcycles, a motorcycle fork is provided which is pivotally secured in relation to the motorcycle's frame to connect the motorcycle's front wheel and axle to its frame. The motorcycle fork typically incorporates a front suspension system and a front wheel brake, and allows the motorcycle to be steered via handlebars fixed in relation to the fork. A common form of motorcycle fork commercially available is a telescopic fork. The telescopic fork typically includes a pair of fork tubes, with one fork tube slidably received within the other fork tube such that the fork tubes are telescopically extendable. The telescopic fork contains several suspension components internally and is designed to compress and extend to adjust for inconsistencies in the riding surface during normal operation of the motorcycle. More specifically, a the telescopically extendable fork tubes contains springs, fork oil, and air, thereby creating a shock absorber for adjusting shock imparted to the front wheel of the motorcycle.

In normal operation of a motorcycle, dust and other fouling gradually accumulates in the fork oil, thereby degrading the performance of the fork. Thus, it is recommended that the fork oil be periodically changed as part of normal maintenance of the motorcycle. In several telescopic fork designs, a small, threaded drain hole is provided in the outer fork tube with a threaded bolt removably received therein, such that removal of the threaded bolt from the drain hole allows fork oil to drain from within the fork tubes. However, absent suitable means to collect the fork oil as it drains from the drain hole, the draining fork oil can often spill onto the exterior of the fork and nearby surfaces, making draining of the fork oil a messy operation. Moreover, the drain hole is typically too small to allow efficient replacement of drained fork oil into the fork tubes through the drain hole. Thus, complete disassembly and reassembly of the motorcycle fork, a complicated and difficult process, is required to allow replacement of the fork oil into the fork tubes.

In light of the above, an apparatus allowing for faster, cleaner, and more convenient changing of motorcycle fork oil is desired.

### BRIEF SUMMARY OF THE INVENTION

A motorcycle fork oil changer useful in draining and replacing the fork oil in a motorcycle fork and an associated method for draining and replacing the fork oil in a motorcycle fork are disclosed. The motorcycle fork oil changer includes a nozzle defining a through opening. The nozzle is adapted to be releasably secured to a motorcycle fork adjacent a drain hole in the motorcycle fork such that the drain hole is placed in at least liquid-tight, fluid communication with the through opening. A plurality of conduits are provided to allow the through opening of the nozzle to be selectively placed in fluid communication with at least one fluid reservoir to facilitate movement of fluid between the reservoir and the motorcycle fork through the drain hole. A valve is provided to regulate fluid flow along the conduits, thus allowing the valve to regulate fluid flow between the fluid reservoir and the drain hole.

A method for operating the motorcycle fork oil changer to accomplish draining and replacing fork oil in a motorcycle fork is also disclosed. In an initial step, the nozzle of the motorcycle fork oil changer is attached to the motorcycle fork with the through opening sealed against the drain hole. Following attachment of the nozzle, a measure of pressurized gas is introduced into the motorcycle fork through the through opening. The valve of the motorcycle fork oil changer is closed to preserve the pressure within the motorcycle fork. The motorcycle fork is positioned such that the drain hole of the motorcycle fork is lower than the surface of the fork oil within the motorcycle fork. The valve is then opened to drain the fork oil from the motorcycle fork. Once at least a portion of the fork oil is drained from within the motorcycle fork, a vacuum source is placed in fluid communication with the motorcycle fork oil changer to create a vacuum within the motorcycle fork. The valve is closed to preserve the vacuum within the motorcycle fork. The motorcycle fork oil changer is then placed in fluid communication with a replacement oil source. The valve is opened, thus allowing replacement oil to be introduced to the motorcycle fork interior. Following introduction of replacement fork oil into the motorcycle fork, the motorcycle fork oil changer is disconnected from the motorcycle fork.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of one embodiment of a motorcycle fork oil changer showing several features of the present invention;

FIG. 2 is a cross-sectional side view of the nozzle portion of the motorcycle fork oil changer of FIG. 1;

FIG. 3 is a side elevation view showing the motorcycle fork oil changer of FIG. 1 adjacent a telescopic motorcycle fork, with various fluid reservoirs illustrated schematically;

FIG. 4 is a flow diagram illustrating one embodiment of a method for draining and replacing fork oil in an motorcycle fork of the present invention;

FIG. 5 is a flow diagram showing in greater detail the method of FIG. 4.

### DETAILED DESCRIPTION OF THE INVENTION

A motorcycle fork oil changer useful in draining and replacing the fork oil in a motorcycle fork and an associated method for draining and replacing the fork oil in a motorcycle fork are disclosed. The motorcycle fork oil changer, or changer, is referred to at 10 herein and in the accompanying Figures. The changer 10 provides a tool for establishing fluid communication with a plurality of fluid reservoirs 60 to allow for movement of fluid into and out from within a motorcycle fork tube through a conventional motorcycle fork drain hole in order to assist in changing the fork oil in the motorcycle fork.

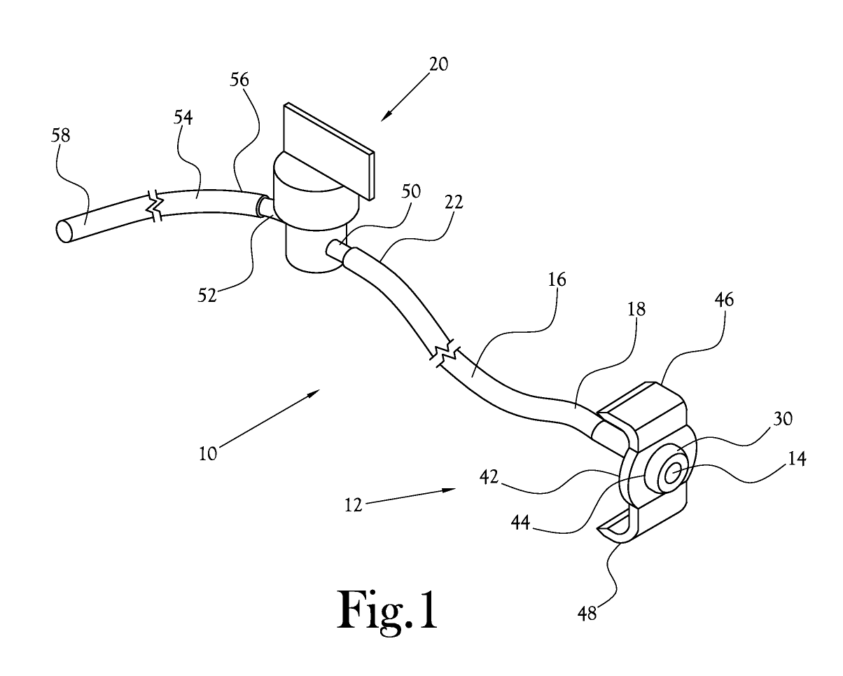

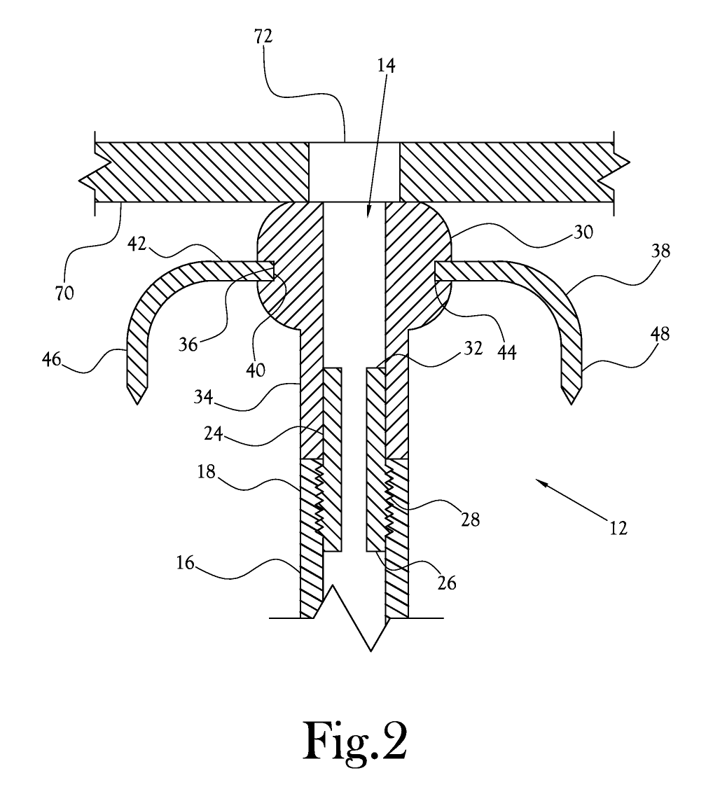

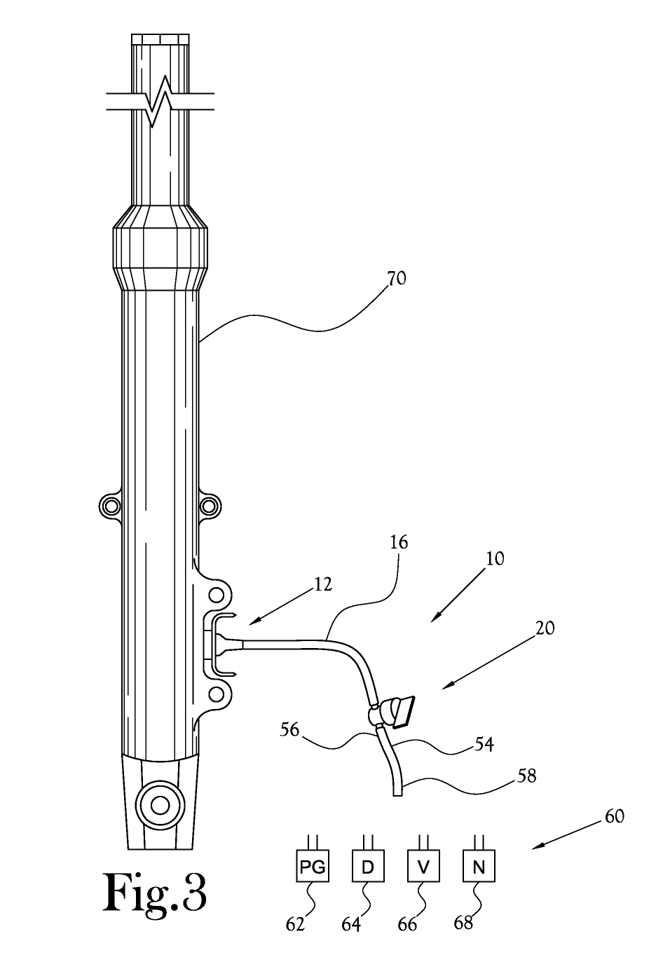

FIG. 1 illustrates a perspective view of one embodiment of a changer 10. As shown in FIG. 1, the changer 10 includes a nozzle 12 defining a through opening 14. The nozzle 12 is adapted to be releasably secured to a motorcycle fork 70 adjacent a drain hole 72 in the motorcycle fork such that the drain hole is placed in at least liquid-tight, fluid communication with the through opening 14 (see FIGS. 2 and 3). As will be described in further detail below, a plurality of conduits 16, 54 are provided to allow the through opening 14 of the nozzle 12 to be selectively placed in fluid communication with at least one fluid reservoir 60 to facilitate movement of fluid between the reservoir 60 and the motorcycle fork through the drain hole. A valve 20 is provided to regulate fluid flow along the conduits 16, 54, thus allowing the valve 20 to regulate fluid flow between the fluid reservoir 60 and the drain hole.

FIG. 2 illustrates a cross-sectional view of the nozzle 12 portion of the changer 10 of FIG. 1. As shown in FIG. 2, the nozzle 12 includes a substantially rigid central tube 24 having a first end 26 and a second end 32. A first flexible elongated conduit 16 is provided having a first end 18 secured to the first end 26 of the central tube 24. In the illustrated embodiment, the central tube first end 26 defines an outer threaded portion 28. The first conduit first end 18 is threaded onto the outer threaded portion 28 of the central tube first end 26 to establish a substantially liquid-tight connection between the central tube first end 26 and the first conduit first end 18. In another embodiment, the central tube first end 26 is received within the first conduit first end 18 to create a frictional connection between the central tube first end 26 and the first conduit first end 18. Those skilled in the art will recognize other means for securing the central tube first end 26 to the first conduit first end 18, such as by mechanical fastening means, welds, adhesives, or by providing a central tube 24 and first conduit 16 as an integral unit, and such other securing means may be used without departing from the spirit and scope of the present invention.

A gasket 30 is provided to extend from the second end 32 of the central tube 24. The gasket 30 is sized to neatly surround a conventional motorcycle fork drain hole 72 and is adapted to engage the portions of the motorcycle fork 70 surrounding the drain hole 72 to establish an at least liquid-tight seal between the drain hole 72 and the central tube 24. In the illustrated embodiment, the gasket 30 surrounds the second end 32 of the central tube 24 and extends from the first conduit first end 18 along the outer surface of the central tube 24 and beyond the central tube second end 32 to allow abutment of the gasket 30 between the motorcycle fork tube and the central tube 24.

A connector 38 is provided to secure the nozzle 12 in place against the motorcycle fork adjacent the drain hole. In the illustrated embodiment, the connector 38 includes a plate 42 having a through bore 44 defining a substantially circular inner lip 40. An outer surface 34 of the gasket 30 defines an annular indentation 36 sized to receive the inner lip 40 of the plate 42 therein and to engage the inner lip 40 to hold the plate 42 fixed in relation to the gasket 30 such that the plate 40 extends outwardly from the gasket 30 substantially perpendicular to the central tube 24. A first peripheral end 46 and opposite second peripheral end 48 of the plate 42 define curved portions extending rearwardly of the through bore 44 toward the central tube first end 26. The curved portions of the first and second peripheral ends 46, 48 serve as hooks which are adapted to engage at least one binding (not shown) to bind the nozzle 12 in place against the motorcycle fork 70 adjacent the drain hole 72. In this manner, the nozzle 12 is adapted to be releasably secured to the motorcycle fork 70 proximate the drain hole 72. Those skilled in the art will recognize other configurations and devices suitable to allow the nozzle 12 to be releasably secured to the motorcycle fork 70 proximate the drain hole 72, and such other configurations or devices may be used without departing from the spirit and scope of the present invention.

It will further be understood that, while the nozzle 12 of the present embodiment includes discreet gasket 30, central tube 24, and connector 38 components, each of these components may be integrally formed with other components of the nozzle 12. For example, in one embodiment, the gasket 30 and the central tube 24 are provided as an integral unit. In another embodiment, the gasket 30, central tube 24, and connector 38 are collectively provided as an integral unit. In yet another embodiment, the gasket 30 extends along the central tube second end 32, while a central portion of the central tube 24 defines the annular ring for receiving and engaging the plate 42 to join the plate 42 to the central tube 24.

Referring to FIG. 1, the valve 20 is provided to be in fluid communication with a second end 22 of the first conduit 16 such that the first conduit 16 establishes at least liquid-tight fluid communication between the valve 20 and the through opening 14 of the nozzle 12. The valve 20 includes at least a first passageway 50 and a second passageway 52 and is provided with at least two valve positions, namely, at least a first position in which fluid flow between the first and second passageways 50, 52 is permitted, and at least a second position in which fluid flow between the first and second passageways 50, 52 is substantially prevented. In the illustrated embodiment, the valve 20 is a standard, quarter-turn rotary valve of the type known to one of skill in the art. Of course, those skilled in the art will recognize other devices, such as clamps, stoppers, or the like, which may be used to regulate fluid flow within the first conduit 16 without departing from the spirit and scope of the present invention.

In the illustrated embodiment, the first passageway 50 of the valve 20 is received within the first conduit second end 22 to establish a frictional connection between the first passageway 50 and the first conduit second end 22 with the first passageway 50 in liquid tight fluid communication with the first conduit 16. A second conduit 54 is provided having a first end 56 connected in liquid tight fluid communication with the second passageway 52 through a similar frictional connection. Those skilled in the art will recognize other means for securing the first conduit second end 22 to the first passageway 50 and the second conduit first end 56 to the second passageway 52, such as by mechanical fastening means, welds, adhesives, or by providing a valve 20 which is integrally formed with either or both of the first or second conduits 16, 54, and such other securing means may be used without departing from the spirit and scope of the present invention.

Referring to FIGS. 1 and 3, a second end 58 of the second conduit 54 is adapted to be removably secured in fluid communication with a plurality of reservoirs 60, including a pressurized gas source 62, a fork oil drain 64, a vacuum source 66, and a replacement fork oil source 68. In the illustrated embodiment, the second conduit 58 is fabricated from a flexible resilient material, such as rubber, thermoplastic, or other such material, such that the second conduit second end 58 is capable of slight deformation to receive a slightly smaller sized outlet therein. In this embodiment, each of the pressurized gas source 62, vacuum source 66, and replacement fork oil source 68 defines an outlet (not shown) capable of being received within the second conduit second end 58 to establish a frictional connection between the outlet and the second conduit second end 58. The fork oil drain 64 defines a receptacle capable of receiving fork oil from the second conduit second end 58 in a manner known to one of ordinary skill in the art. Additionally, in one embodiment, at least a portion of at least one of the first and second conduits 16, 54 is translucent, such that a user of the changer 10 is able to determine the presence of fluid inside the first and second conduits 16, 54.

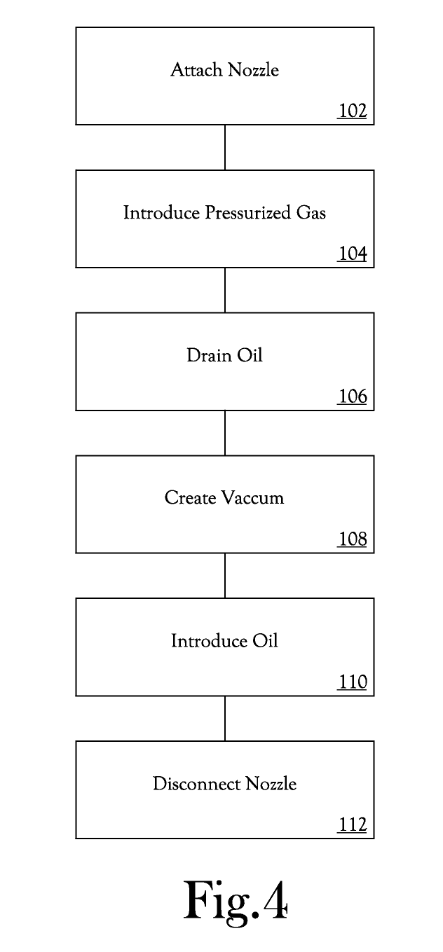

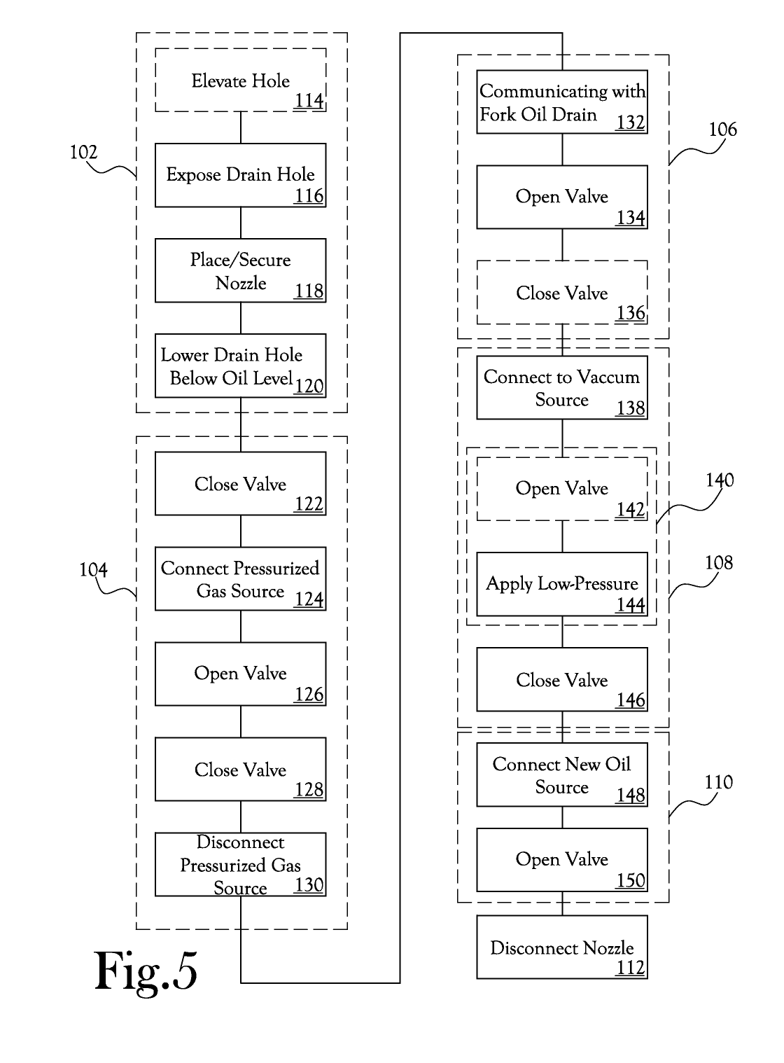

FIGS. 4 and 5 are a series of flow charts illustrating one embodiment of a method 100 for draining and replacing fork oil in a motorcycle fork of the present invention. Specifically, FIG. 4 is a flow chart illustrating one embodiment of the method 100, while FIG. 5 is a flow chart illustrating in greater detail the steps of the method 100 shown in FIG. 4. In the illustrated embodiment of FIGS. 4 and 5, a typical design of a telescopic motorcycle fork 70 is used, in which the fork 70 includes a drain hole 72 with a threaded bolt 74 received therein.

Referring to FIG. 4, in an initial step, 102, the nozzle 12 is attached to the motorcycle fork 70 with the through opening 14 sealed against the drain hole 72. As shown in FIG. 5, the step 102 of attaching the nozzle 12 is accomplished by performing a series of inclusive steps. In an optional initial step to discourage spillage of fork oil from the motorcycle fork 70, the fork 70 is oriented 114 such that the drain hole 72 is elevated substantially above the level of fork oil within the fork 70. Thereafter, the threaded bolt 74 is removed from the drain hole 72, thereby exposing 116 the drain hole 72. Following exposure 116 of the drain hole 72, the nozzle 12 is placed 118 against the motorcycle fork 70 with the gasket 30 surrounding and engaging the exterior of the drain hole 72 to establish the through opening 14 and the drain hole 72 in fluid communication. The connector 38 is then configured to secure the nozzle 12 in place against the motorcycle fork 70. For example, as discussed above, in the one embodiment a plurality of flexible bindings (not shown) are provided to engage the curved portions of the first and second peripheral ends 46, 48 of the plate 42, and to wrap around the exterior of the motorcycle fork 70, thereby binding the nozzle 12 in place against the fork 70. Thereafter, the motorcycle fork 70 is reoriented 120 such that the drain hole 72 is held below the level of the fork oil within the motorcycle fork 70.

Following attachment 102 of the nozzle 12, a measure of pressurized gas is introduced 104 into the motorcycle fork. Referring to FIG. 5, the valve 20 is closed 122. The second end 58 of the second conduit 54 is connected 124 to a pressurized gas source 62. Thereafter, the valve 20 is opened 126, thereby allowing a measure of pressurized gas to travel through the valve 20 and the through opening 14 and to enter the interior of the motorcycle fork 70. Thereafter, the valve 20 is closed 128, and the pressurized gas source 62 is disconnected from the second end 58 of the second conduit 54.

It will be understood that, once the pressurized gas is introduced 104 into the interior of the motorcycle fork 70 and the motorcycle fork 70 is oriented 120 such that the drain hole 72 is held below the level of the fork oil within the motorcycle fork 70, the tendency of the gas in the interior of the motorcycle fork 70 to reach a state of pressure equilibrium with the atmosphere surrounding the motorcycle fork 70 results in increased pressure exerted on the fork oil. Specifically, the pressurized gas within the motorcycle fork 70 tends to force the fork oil from within the motorcycle fork 70 outward through the drain hole 72. It will further be understood that, with the changer 10 installed over the drain hole 72 and the valve 20 in a closed position, the closed valve 20 prevents drainage of the fork oil through the changer 10. Accordingly, following introduction 104 of pressurized gas into the interior of the motorcycle fork 70 and subsequent closing of the valve 128, the pressurized gas source 62 is disconnected 130 from the second end 58 of the second conduit 54, and the fork oil is drained 106 from the motorcycle fork 70. As shown in FIG. 5, the second end 58 of the second conduit 54 is placed 132 in fluid communication with the fork oil drain 64. The valve 20 is then opened 134 to allow at least a portion of the fork oil within the motorcycle fork 70 to be pushed outward through the drain hole 72 and changer 10, and to allow the oil to drain into the fork oil drain 64. In an optional step 136, the valve 20 is again closed to arrest drainage of fork oil through the changer 10.

Once at least a portion of the fork oil is drained 106 from within the motorcycle fork 70, a vacuum is created 108 within the motorcycle fork 70. In the embodiment of FIG. 5, the second conduit second end 58 is connected 138 to the vacuum source 66. The vacuum source 66 is configured to apply a low-pressure differential to the interior of the changer 10, thereby creating 140 a low-pressure vacuum within the motorcycle fork 70. In an embodiment of the method invention in which the valve 20 is closed 136 following drainage of the fork oil into the fork oil drain 64, the valve is re-opened 142 to allow the vacuum source 66 to be placed in fluid communication with the motorcycle fork interior, thus allowing the vacuum source 66 to subsequently apply 144 the low-pressure differential to create the low-pressure vacuum within the motorcycle fork 70. Once the low-pressure vacuum is created 140 within the motorcycle fork 70, the valve 20 is again closed 146 to substantially maintain the low-pressure vacuum and to discourage equalization of pressure between the interior and exterior of the motorcycle fork 70.

Following closure of the valve 20 to secure the low-pressure vacuum within the motorcycle fork 70, replacement oil is introduced 110 to the motorcycle fork interior. The second conduit second end 58 is removed from the vacuum source 66 and connected 148 to a replacement fork oil source 68. The replacement fork oil source 68 is configured to provide a measure of replacement fork oil to the second conduit sufficient to refill the fork oil within the motorcycle fork 70 to a level acceptable for operation of the fork. Upon connection 148 of the replacement fork oil source 68, the valve 20 is opened 150, thus allowing the low-pressure vacuum inside the motorcycle fork 70 to draw replacement fork oil from the replacement fork oil source 68 through the changer 10 and into the motorcycle fork 70. It will be understood that the amount of fork oil provided to the motorcycle fork 70 by the replacement fork oil source 68 is dependent upon the amount of fork oil drained from the fork during the drainage step 106, the strength of the low-pressure vacuum created 108 within the fork, and the amount of fork oil specified for use in the specific motorcycle fork 70. For example, in one embodiment, the replacement fork oil source 68 is configured to hold a pre-determined amount of replacement fork oil determined to be sufficient to return the fork oil level in the motorcycle fork 70 to within a predetermined range of levels deemed acceptable for an intended use of the motorcycle fork 70. In another embodiment, the replacement fork oil source 68 holds an amount of replacement fork oil excessive to the needs of the fork oil changing process. In this embodiment, the amount of replacement fork oil drawn into the motorcycle fork 70 is controlled by adjusting the strength of the low-pressure vacuum provided by the vacuum source 66. Alternatively, the amount of replacement fork oil drawn into the motorcycle fork 70 is limited by closing the valve 20 once a sufficient amount of replacement fork oil is drawn. Following introduction 110 of replacement fork oil into the motorcycle fork 70, the changer 10 is disconnected 112 from the motorcycle fork 70. If no additional maintenance or repair is to be performed on the motorcycle fork 70 which requires the threaded bolt 74 to be removed, the threaded bolt 74 is replaced within the drain hole 72 in order to return the motorcycle fork 70 to proper working order.

From the foregoing description, it will be recognized by those skilled in the art that a motorcycle fork oil changer and an associated method for draining and replacing the fork oil in a motorcycle fork has been provided. The motorcycle fork oil changer and associated method are useful to provide a clean and convenient apparatus and method for draining and replacing the fork oil in a motorcycle fork. While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A motorcycle fork oil changer useful with a motorcycle fork of the type defining a drain hole allowing access to an interior of the motorcycle fork for draining at least a portion of motorcycle fork oil within the motorcycle fork, said motorcycle fork oil changer comprising:
a nozzle defining a through opening and having a gasket configured to surround the drain hole to establish an at least liquid tight seal between the drain hole and the through opening; and
a valve in at least liquid tight fluid communication with said through opening, said valve being at least openable and closable to regulate fluid flow through said through opening;
whereby said valve is capable of being placed in at least liquid tight fluid communication with a fluid reservoir to regulate movement of fluid between the fluid reservoir and the motorcycle fork interior through the drain hole.

2. The motorcycle fork oil changer of claim 1, said nozzle further comprising a central tube having a first end and a second end and defining said through opening, said central tube first end being in fluid communication with said valve, said gasket substantially surrounding and extending from said central tube second end.

3. The motorcycle fork oil changer of claim 2 further including a first conduit having a first end in fluid communication with said central tube first end, said first conduit having a second end in fluid communication with said valve.

4. The motorcycle fork oil changer of claim 3, said central tube first end defining an outer threaded portion, said first conduit first end being threaded onto said outer threaded portion of said central tube first end to establish a substantially liquid-tight connection between said central tube first end and said first conduit first end.

5. The motorcycle fork oil changer of claim 3, said first conduit being formed from a translucent material.

6. The motorcycle fork oil changer of claim 3 further including a second conduit having a first end in fluid communication with said valve, said second conduit having a second end being adapted to connect in at least liquid tight fluid communication with a fluid reservoir.

7. The motorcycle fork oil changer of claim 6, said second conduit being formed from a translucent material.

8. The motorcycle fork oil changer of claim 2, said nozzle further comprising a connector for removably securing said nozzle adjacent the motorcycle fork with said gasket surrounding the drain hole.

9. The motorcycle fork oil changer of claim 8, said connector comprising a plate having a through bore defining a substantially circular inner lip, said nozzle defining an annular indentation sized to receive and engage said inner lip to hold said plate in fixed relation to said gasket.

10. The motorcycle fork oil changer of claim 9, said plate having curved opposite first and second side portions defining at least one hook for engaging a fastener.

11. The motorcycle fork oil changer of claim 9, said annular lip being defined by said gasket.

12. The motorcycle fork oil changer of claim 1, said nozzle further comprising a connector for removably securing said nozzle adjacent the motorcycle fork with said gasket surrounding the drain hole.

13. The motorcycle fork oil changer of claim 12, said connector comprising a plate having a through bore defining a substantially circular inner lip, said nozzle defining an annular indentation sized to receive and engage said inner lip to hold said plate in fixed relation to said gasket.

14. The motorcycle fork oil changer of claim 13, said plate having curved opposite first and second side portions defining at least one hook for engaging a fastener.

15. A motorcycle fork oil changer useful with a motorcycle fork of the type defining a drain hole allowing access to an interior of the motorcycle fork for draining at least a portion of motorcycle fork oil within the motorcycle fork, said motorcycle fork oil changer comprising:
a valve having at least two passageways, said valve defining an open position in which fluid flow between said at least two passageways is allowed and a closed position in which fluid flow between said at least two passageways is prevented;
a first sealing means for placing a first of said at least two passageways in at least liquid tight fluid communication with the drain hole; and
a second sealing means for selectively placing at least a second of said at least two passageways in at least liquid tight fluid communication with a fluid reservoir;
whereby when said valve is placed in at least liquid tight fluid communication with said fluid reservoir and said valve is placed in said open position, said fluid reservoir is configured to instigate fluid flow through said valve and the drain hole between said fluid reservoir and the motorcycle fork interior.

16. The motorcycle fork oil changer of claim 15, said first sealing means comprising a gasket sized to surround said drain hole to establish an at least liquid tight seal between the drain hole and the gasket.

17. The motorcycle fork oil changer of claim 16, said first sealing means further comprising an elongated, flexible conduit in fluid communication between said first passageway and said gasket.

18. The motorcycle fork oil changer of claim 15, said second sealing means comprising an elongated, flexible conduit in fluid communication with said second passageway.

19. A method for changing motorcycle fork oil in a motorcycle fork of the type having a drain hole allowing access to an interior of the motorcycle fork, said method comprising the steps of:
(A) providing a nozzle defining a through opening and having a gasket configured to surround the drain hole to establish an at least liquid tight seal between the drain hole and the through opening and a valve in at least liquid tight fluid communication with said through opening, said valve being at least openable and closable to regulate fluid flow through said through opening;
(B) securing said nozzle adjacent the motorcycle fork with said gasket substantially surrounding the drain hole to establish an at least liquid tight seal between the drain hole and the through opening;
(C) introducing a measure of pressurized gas into the motorcycle fork through said through opening and the drain hole;
(D) allowing said pressurized gas to push motorcycle fork oil from the motorcycle fork through the drain hole;
(E) creating a low-pressure vacuum within the motorcycle fork and closing said valve to maintain said low-pressure vacuum;
(F) placing a replacement oil source in fluid communication with said through opening; and
(G) opening said valve to allow replacement oil to enter the motorcycle fork through the drain hole.

20. The method of claim 19, said step of creating a low-pressure vacuum within the motorcycle fork comprising the steps of:
(Ea) placing said valve in fluid communication with a vacuum source capable of applying a low-pressure differential to the motorcycle fork interior through said through opening and the drain hole;
(Eb) opening said valve to allow said vacuum sorce to apply said low-pressure differential;
(Ec) closing said valve.
